(19) United States
(12) Patent Application Publication
(10) Pub. No.: US 2016/0119673 A1
(43) Pub. Date: Apr. 28, 2016

(54) System and Method for Transmitting, Receiving, and Displaying High Resolution Images

(71) Applicant: Aaron William Rees, Naperville, IL (US)

(72) Inventor: Aaron William Rees, Naperville, IL (US)

(21) Appl. No.: 14/871,172

(22) Filed: Sep. 30, 2015

Related U.S. Application Data
(60) Provisional application No. 62/069,730, filed on Oct. 28, 2014.

(51) Int. Cl. H04N 21/4402; H04N 21/433; H04N 21/2662

(52) U.S. Cl. CPC H04N 21/440263; H04N 21/2662; H04N 21/440218; H04N 21/433

(57) ABSTRACT

A system for displaying high resolution images on a high resolution display system includes a network server, a first electronic device, and a high resolution display. The network server includes an image library database including multiple coded image files, and a display module for transmitting display information in response to a display request. Each image file is configured to be decoded into a video image data stream when a decoder executable file is executed by a processor, is created from one or more high resolution image files with a coder executable file, includes all of the image data included in each high resolution image file, and has a size smaller than the total size of all the one or more high resolution image files. The video image data stream includes all the image data of the one or more high resolution image files. The display module includes information on the coded image files included in the image library database; and a user interface for selecting and downloading coded image files.

### PRIORITY

This application claims priority to and incorporates by reference in its' entirety, U.S. Provisional Patent Application No. 62/069,730, entitled “System and Method For Transmitting, Receiving, and Displaying High Resolution Images”, and filed Oct. 28, 2014.

### TECHNICAL FIELD

The present invention generally relates to systems and methods for transmitting, receiving, and displaying high resolution images, and in particular to a marketplace computer network system for delivering and displaying sequences of high resolution images.

### BACKGROUND

Electronic display devices, such as televisions, with the capability of displaying high definition and ultra-high definition images and video, are now available to the public. However, it is difficult to find and procure high definition and ultra-high definition image and video media to play on these electronic devices. When image signals (such as television station, satellite, and cable) are sent to an electronic device for display, the image files are generally compressed in a process which causes the images to lose definition. This process allows for speed of transmitting and displaying images, but may degrade the final visual effect. High definition and ultra-high definition videos may be available on tangible media, such as DVDs and memory sticks, but computer or other electronic devices may not have a processor which is powerful enough to send the image streams to the display at a speed necessary to watch a video with a high definition image. Video production studios may edit movies or other videos with computers which have large and powerful enough processors to view videos in high definition. But, these computers may be too expensive to be commercially viable for a broad market.

Photographic artists now have the equipment to produce artistic moving videos, or sequences of images, in high or ultra-high definition digital files. For example, photographic artists can produce time lapse photography of many of nature's most beautiful scenes. However, these artists may not have a medium through which to market their photographic art in high or ultra-high definition digital files.

As can be seen, there may be an ongoing need to provide a means for transmitting and displaying sequences of high resolution images at a high rate of speed, and providing a means for photographic artists to market and deliver their high definition art to the public.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

In one aspect of the present invention, system for displaying high resolution images on a high resolution display is disclosed. The system includes a network server, a first electronic device, and a high resolution display. The network server includes an image library database including multiple coded image files, and a display module for transmitting display information in response to a display request. Each image file is configured to be decoded into a video image data stream when a decoder executable file is executed by a processor, is created from one or more high resolution image files with a coder executable file, includes all of the image data included in each high resolution image file, and has a size smaller than the total size of all the one or more high resolution image files. The video image data stream includes all the image data of the one or more high resolution image files. The display module includes information on the coded image files included in the image library database; and a user interface for selecting and downloading coded image files. The first electronic device is communicatively connected to the network server and includes a user interface for receiving display information, and selecting and downloading coded image files. The first electronic device is configured to execute the decoder executable file with data from a downloaded coded image file and generate the video image data stream. The high resolution display is communicatively connected to the first electronic device and configured to generate a sequence of high resolution images in response to receiving the video image data stream from the first electronic device at a rate of at least twenty-four frames per second.

In another aspect of the present invention, a computer program product, including a computer readable storage medium, and computer usable code stored on the computer readable storage medium is disclosed. If executed by a processor, the computer readable code causes a computer to receive a coded image file from an image provider via an image coder electronic device, store the coded image file in an image library database; transmit display signals to an image decoder electronic device, in response to a request for available coded image file information from an image consumer via the image decoder electronic device; and transmit the coded image file in response to an image request from the image consumer via the image decoder electronic device. The coded image file is created from one or more high resolution image files with a coder executable file, includes all of the image data included in each high resolution image file, and has a size smaller than the total size of all the one or more high resolution image files. The display signals are indicative of information on the coded image file and other image files available in the image library database. The location of the electronic device is designated by the image request.

These and other features, aspects and advantages of the present invention will become better understood with reference to the following drawings, description and claims.

### BRIEF DESCRIPTION OF THE DRAWINGS

FIG. 1 is a schematic of a system for transmitting, receiving, and displaying high resolution images, according to an exemplary embodiment of the present invention.

FIG. 2 is a diagram illustrating an exemplary method for transmitting, receiving, and displaying high resolution images, according to an exemplary embodiment of the present invention.

FIG. 3 is a block diagram of an exemplary method for creating a smaller lossless coded image file from a high resolution image file, according to an exemplary embodiment of the present invention.

FIG. 4 is a block diagram of an exemplary method for creating a display of a sequence of high resolution images from a lossless coded image file, according to an exemplary embodiment of the present invention.

FIG. 5 is a flow chart of a method of providing high resolution image files to a computer network marketplace, according to an exemplary embodiment of the present invention.

FIG. 6A is a flow chart of a first portion of a method of providing a computer network marketplace, according to an exemplary embodiment of the present invention.

FIG. 6B is a flow chart of a second portion of the method of providing a computer network marketplace of FIG. 6A.

FIG. 7 is a flow chart of a method of displaying a sequence of high resolution image from a computer network marketplace on a display, according to an exemplary embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above, or may only address one of the problems discussed above. Further, one or more of the problems discussed above may not be fully addressed by any of the features described below.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. The computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

For the purposes of this description, a codec is computer readable code stored on a computer readable medium, which when executed by a processor, encodes or decodes a digital data stream, signal, or computer file. For purposes of this description, a lossless codec is a codec including a coder executable file for encoding a data image file, and a decoder executable file for decoding the coded image file. When executed by a processor, the coder executable file encodes a data image file containing digital image data into a coded image file. The coded image file is smaller than the data image file. When executed by a processor, the decoder executable file decodes the coded image file into a video image data stream which perfectly reconstructs the original digital image data.

For purposes of this description, an ultra-high definition (UHD) 8K data image file is a data image file including digital data for an image with at least 7680×4320 pixels (7680 rows by 4320 columns of pixels). For purposes of this description, having at least a first number of rows by a second number of columns of pixels means the data image file contains information on the number of pixels in that array (not necessarily the same number rows and columns), and has information on each pixel. For purposes of this description, an UHD 4K data image file is a data image file including digital data for an image with at least 3840×2160 pixels (3840 rows by 2160 columns of pixels). For purposes of this description an UHD date image file includes an UHD 8K and/or a UHD 4K data image file. For purposes of this description, a-high definition (HD) data image file is a data image file including digital data for an image with at least 1920×1080 pixels (1920 rows by 1080 columns), or 1280×720 pixels (1280 rows by 1080 columns). For purposes of this description, a standard definition (SD) data image file is a data image file including digital data for an image with at least 640×480 pixels (640 rows by 480 columns). For purposes of this description, a high resolution image is a HD image and/or an UHD image.

For purposes of this description, an ultra-high definition (UHD) 8K data display is a display device which is configured to display an image with at least 7680×4320 pixels (7680 rows by 4320 columns of pixels). For purposes of this description, displaying at least a first number of rows by a second number of columns of pixels means the display is configured to be capable of displaying the number of pixels in that array (not necessarily the same number rows and columns), and is capable of displaying each pixel. For purposes of this description, an UHD 4K display is a display device which is configured to display an image with at least 3840×2160 pixels (3840 rows by 2160 columns of pixels). For purposes of this description an UHD display includes an UHD 8K and/or an UHD 4K display. For purposes of this description, a-high definition (HD) display is a display device which is configured to display an image with at least 1920×1080 pixels (1920 rows by 1080 columns), or 1280×720 pixels (1280 rows by 1080 columns). For purposes of this description, a standard definition (SD) data image file is display is a display device which is configured to display an image with at least 640×480 pixels (640 rows by 480 columns). For purposes of this description, a high resolution display includes a HD display and/or an UHD display.

Electronic display devices, such as televisions, with the capability of displaying high definition and ultra-high definition images and video, are now available to the public. However, it is difficult to find and procure high definition and ultra-high definition image and video media to play on these electronic devices. When image signals (such as television station, satellite, and cable) are sent to an electronic device for display, the image files are generally compressed in a process which causes the images to lose definition. This process allows for speed of transmitting and displaying images, but may degrade the final visual effect. High definition and ultra-high definition videos may be available on tangible media, such as DVDs and memory sticks, but computer or other electronic devices may not have a processor which is powerful enough to send the image streams to the display at a speed necessary to watch a video with a high definition image. Video production studios may edit movies or other videos with computers which have large and powerful enough processors to view videos in high definition. But, these computers may be too expensive to be commercially viable for a broad market. There is a need for a system which will make high definition and ultra-high definition videos commercially available to the public. There is also a need for a system which will transmit the separate images of the video at a fast enough rate for a display to play them.

Photographic artists now have the equipment to produce artistic videos, and/or sequences of images, in high or ultra-high definition digital files. For example, photographic artists can produce time lapse photography of many of nature's most beautiful scenes, cityscapes lighting up at night and/or transitioning into daylight, traffic scenes, and or other scenes. Photographers can also sweep panoramic views of different areas or attractions. This photographic or video art, shown on a HD or and UHD display has many uses. For example, HD or UHD scenes of nature may have a calming effect when shown on a doctor's office wall or other areas where people may be stressed. When the HD or UHD scenes are hung on walls in windowless rooms, or rooms with limited windows, they may create the impression of windows, give light, and create the illusion of more space. When shown in shop or other windows, the HD or UHD scenes playing on displays may attract customers. Sound may also be a part of this new type of photographic art.

However, artists creating these video arts may not have a medium through which to market their photographic art HD or UHD digital files. It is difficult to transmit these large files through the Internet or other on-line file transfer techniques. In addition, consumers have no one place to look for the type of photographic art they wish to display on a HD or UHD display. Consumers may also lack the hardware necessary for transmitting to a display a series of HD or UHD image files at an acceptable speed. A centralized on-line marketplace which can deliver HD or UHD photographic art to consumers is needed, along with hardware which is affordable to transmit to the art to a display at an acceptable speed.

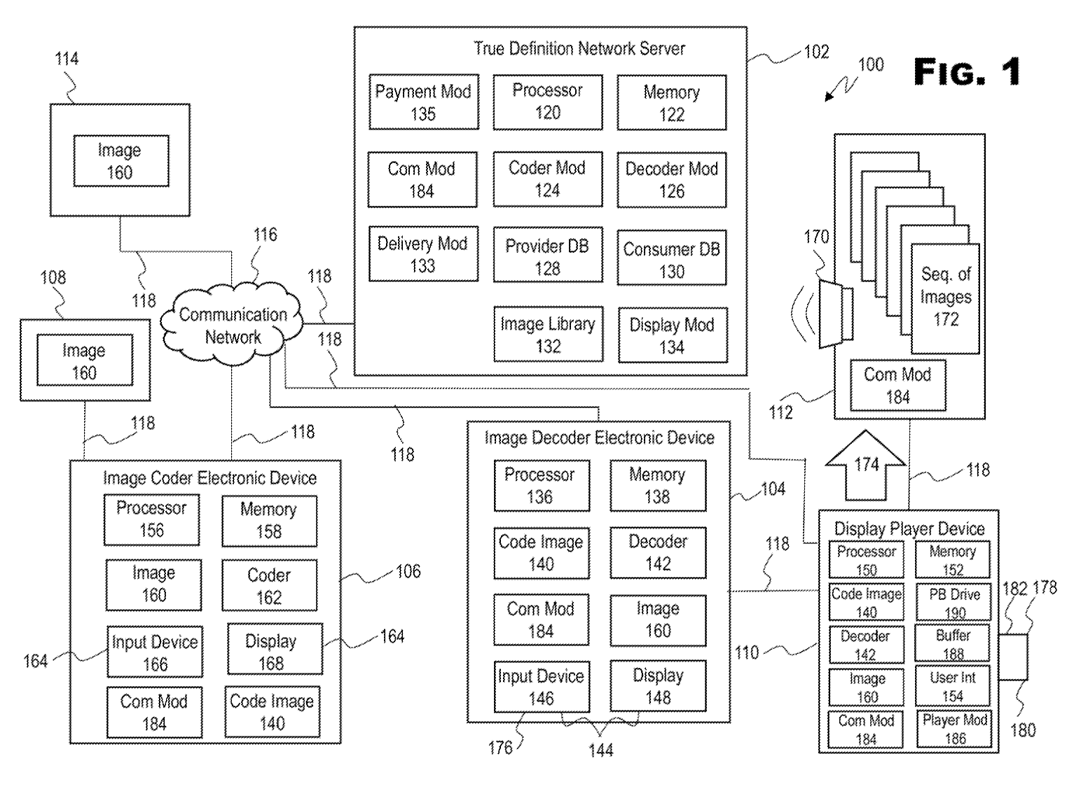

Referring now to FIG. 1, a system 100 for transmitting, receiving, and displaying images, the images including high resolution images is illustrated. The system 100 may include a true definition network server (TDNS) 102, am image decoder electronic device (IDED) 104, an image coder electronic device (ICED) 106, an image creation device 108, a display player device (DPD) 110, a display 112, and a content server 114.

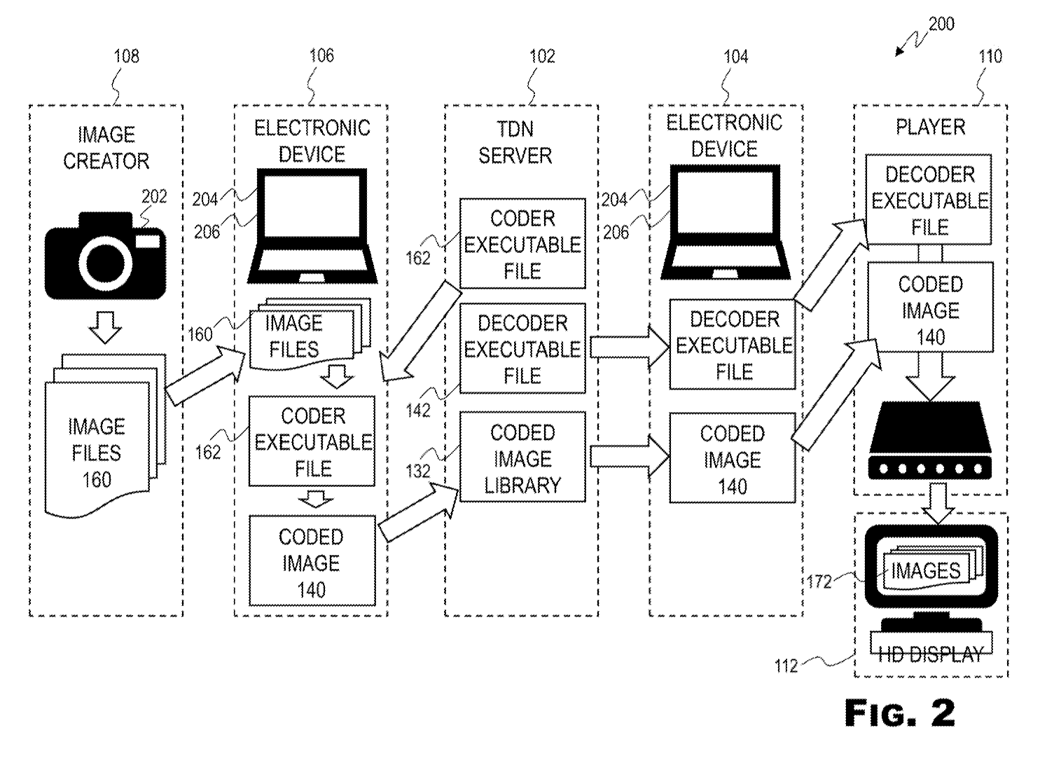

The TDNS 102 may include any computer or operatively connected group of computers running a software application capable of accepting requests from a client and giving responses accordingly to implement methods described in this description and illustrated in the drawings. In some embodiments, operations other than those described herein may also run on the computer, and executable program code and data other than that described herein may also be stored in a within the computer. The TDNS 102 may include a processor 120 and a memory component 122. The processor 120 may include microprocessors or other processors as known in the art and capable of executing instructions, as described below and in relation to FIGS. 2-5, 6A-6B, and 7. In some embodiments the processor 120 may include multiple processors which may be operably connected. Such instructions may be read into or incorporated into a computer readable medium, such as the memory component 122, or provided external to processor 120. The instructions may include multiple lines or divisions multiple lines or divisions of code. The lines or divisions of code may not be in consecutive order, and may not be located in the same section of code. In alternative embodiments, hard-wired circuitry may be used in place of or in combination with software instructions as described above, below, or in relation to the drawings. The memory component 122 may include computer readable storage medium as described above. In some embodiments the memory component 122 may include multiple memory components.

The TDNS 102 may include an image coder module 124. The image coder module 124 may provide to providers of photographic art a coder executable file 162 which may be a lossless codec which the provider may use to compress one or more image files 160 with no loss of image data. The image coder module 124 may also compress one or more image files 160 contained in an image library database 132 with the coder executable file 162 for delivery to a consumer who has requested the image files 160. The image coder module 124 may include executable computer program code, and data stored on computer readable storage medium in the memory component 122, which when executed by the processor 120 may implement instructions of the methods shown and described in relation to FIGS. 2-5, 6A-6B, and 7. Although illustrated as a single component, the lines or divisions of the executable computer program code need not be stored in consecutive order, and may not be located in the same section of code, or in the case of multiple memory components 122, the same memory component.

The TDNS 102 may include an image decoder module 126. The image decoder module 126 may provide to consumers of photographic art a decoder executable file 142 which may be a lossless codec which the consumer may use to decode one or more coded image files 140 with no loss of image data for display on the display 112. The image decoder module 126 may also decode one or more coded image files 140 contained in an image library database 132 with the decoder executable file 142 for delivery to a consumer who has requested the image files 140 in a decoded image file for delivery on a tangible computer medium such as a memory stick, DVD, or other means as known in the art. The image decoder module 126 may include executable computer program code, and data stored on computer readable storage medium in the memory component 122, which when executed by the processor 120 may implement instructions of the methods shown and described in relation to FIGS. 2-5, 6A-6B, and 7. Although illustrated as a single component, the lines or divisions of the executable computer program code need not be stored in consecutive order, and may not be located in the same section of code, or in the case of multiple memory components 122, the same memory component.

The TDNS 102 may include a provider database 128. The provider database 128 may include image provider data associated with information on image providers who have signed up for system 100 image provider accounts to display and/or offer for sale their photographic art through system 100. The provider database 128 may include payment data associated with those providers, and data associating specific image files 160 and/or coded image files 140 in the image library database 132 with those providers. The payment data may include, for example, information a bank account or other account to which payment for sending image files 140, 160 associated with the provider may be paid. The provider database 128 may include data stored on computer readable storage medium in the memory component 122, which may be used by the processor 120 when implementing instructions of the methods shown and described in relation to FIGS. 2-5, 6A-6B, and 7. Although illustrated as a single component, the lines or divisions of the data need not be stored in consecutive order, and may not be located in the same section of code, or in the case of multiple memory components 122, the same memory component.

The TDNS 102 may include a consumer account database 130. The consumer account database 130 may include consumer data associated with information on consumers who have signed up for system consumer accounts, payment data associated with those consumers, and data associating specific image files 160 and/or coded image files 140 in the image library database 132 which a consumer may have purchases or shown interest in with that consumer. The payment data may, for example, include bank account, credit card, and/or other payment information on ways the consumer desires to pay for image files 140, 160 from the image library database 132. The consumer database 130 may include data stored on computer readable storage medium in the memory component 122, which may be used by the processor 120 when implementing instructions of the methods shown and described in relation to FIGS. 2-5, 6A-6B, and 7. Although illustrated as a single component, the lines or divisions of the data need not be stored in consecutive order, and may not be located in the same section of code, or in the case of multiple memory components 122, the same memory component.

The TDNS 102 may include the image library database 132. The image library database 132 may include coded image files 140 and uncoded image files 160. The image files 140, 160 may include one image or a sequence of images 172 (or frames) which may be displayed on the display 112 as a video presentation. The image files 140, 160 may include audio data which may play on an audio device 170 of the display 112 (such as a speaker) along with the video presentation. The image library database 132 may include data stored on computer readable storage medium in the memory component 122, which may be used by the processor 120 when implementing instructions of the methods shown and described in relation to FIGS. 2-5, 6A-6B, and 7. Although illustrated as a single component, the lines or divisions of the data need not be stored in consecutive order, and may not be located in the same section of code, or in the case of multiple memory components 122, the same memory component.

The TDNS 102 may include a display module 134. The display module 134 may send display information to the IDED 104, such that the IDED 104 may provide a user interface 144 for a consumer to interact with the TDNS 102. For example, the display module 134 may include computer code, such as HTML, which when accessed by the IDED 104, interacts with an Internet browser on the IDED 104 to provide a user interface 144 through the Internet browser. In another example, when the IDED 104 is an electronic tablet or phone, the display module 134 may interact with an app on the IDED 104 which may serve as a user interface 144. The display information may include an interface with the image library database 132 for a consumer to view icons and information indicative of image files 140, 160 contained in the image library database 132. The display information may include an interface for the consumer to add consumer information to the consumer database 130. The display information may include an interface with a payment module 136 for the consumer to make payments for desired image files 140, 160. The display information may include an interface with a delivery module 133 for the consumer to choose a desirable delivery methods for an image file 140, 160. The display module 134 may include executable computer program code, and data stored on computer readable storage medium in the memory component 122, which when executed by the processor 120 may implement instructions of the methods shown and described in relation to FIGS. 2-5, 6A-6B, and 7. Although illustrated as a single component, the lines or divisions of the executable computer program code and data need not be in consecutive order, and may not be located in the same section of code, or in the case of multiple memory components 122, the same memory component.

The TDNS 122 may include a payment module 135. The payment module 135 may be configured to facilitate a payment by the consumer making an image file 140, 160 purchase, or purchasing the decoder executable file 142 with the IDED 104. The payment may be made in a manner and to an account in the provider database 128 associated with the provider of the image file 140, 160. The payment may be made in a manner and from an account associated with the consumer in the consumer database 130. In another embodiment, the consumer may enter a manner and an account for the payment to be made from on the user interface 144 of the IDED 104. The payment module 135 may include executable computer program code, and data stored on computer readable storage medium in the memory component 122, which when executed by the processor 120 may implement instructions of the methods shown and described in relation to FIGS. 2-5, 6A-6B and 7. Although illustrated as a single component, the lines or divisions of the executable computer program code and/or data need not be in consecutive order, and may not be located in the same section of code, or in the case of multiple memory components 122, the same memory component 122.

The TDNS 122 may include a delivery module 133. The delivery module 133 may be configured to facilitate delivery to the consumer of a purchased image file 140, 160. The delivery may be made in a manner and to a location associated with the consumer in the consumer database 130. In another embodiment, the consumer may enter a preferred delivery method, address, or electronic device identifier on the user interface 144 of the IDED 104. Choices of delivery methods may include for example, but are not limited to, immediate download of a coded image file 140, delayed download of a coded image file 140, mailing of an image file 160 on a memory stick or other storage device, or other methods known in the art. Delivery addresses may include geographic addresses to which physical mail can be delivered to, and/or electronic device identifiers and network addresses to which electronic files may be downloaded. The delivery module 133 may schedule and implement the delivery of an electronic file. The delivery module 133 may facilitate the delivery of a file on a tangible storage media by mail through facilitating download of the file, printing mailing labels, and/or sending instructions to a mailing facility which will handle packaging, shipping, and the like. The delivery module 133 may include executable computer program code, and data stored on computer readable storage medium in the memory component 122, which when executed by the processor 120 may implement instructions of the methods shown and described in relation to FIGS. 2-5, 6A-6B and 7. Although illustrated as a single component, the lines or divisions of the executable computer program code and/or data need not be in consecutive order, and may not be located in the same section of code, or in the case of multiple memory components 122, the same memory component 122.

The TDNS 102 may include a communication module 184 to send and receive data from other electronic and computer devices through communication links 118 and communication networks 116. The communication module 184 may include one or more receivers and transmitters, executable computer program code and data stored on computer readable storage medium in the memory component 122, and other interfaces for communication as known in the art. The communication module 184 may allow the TDNS 102 to communicate using multiple types of communication methods, links, and protocols. Non-limiting examples of networks the communication module 184 may support include wireless networks, data or packet networks, publicly switched telephone networks (PSTN), cellular networks, wide area networks (WAN), and adjacent local area networks (LAN).

The TDNS 102 may be communicatively connected to the IDED 104, the ICED 106, and the content server 114 through the communication links 118 and the communication network 116. The communication links 118 may be links which connect computer and/or electronic devices to networks 116. Communicative links 116 may include physical electrical, fiber optic, or other cables, cellular technology linking devices, internet linking devices such as DSL or regular phones lines, cable service lines, cell towers, satellite linking devices, satellites, and/or other communicative links. The communication network 116 may include the Internet, cellular networks, satellite networks, and/or combinations of these and other similar communication networks which tie electronic and/or computer devices together.

The IDED 104 and the DPD 110 may take on a number of different embodiments. In some embodiments, the IDED 104 and DPD 110 are one physical device, and components illustrated separately (such as a processor 136, 150, a memory component 138, 152, or a communication module 184) may actually be one component which performs the functions described for the IDED 104 and the DPD 110. In another embodiment, the IDED 104 and the DPD 110 may be separate devices, and components or functionality described for one of these devices may actually be located or performed, respectively, by the other. In some embodiments, the IDED 104 may be two or more devices. For example, one device may be used to communicate an order for an image file 140, 160 to the TDNS 102, and the image file 140, 160 may be downloaded to another device. The IDED 104 and the DPD 110 may be communicatively connected through communication link 118, or may communicate through the communication network 116. In some embodiments, the coded image file 140 may be downloaded to the IDED 104, decoded on the IDED 104, and then saved to a tangible storage medium such as a memory stick. The memory stick may then be connected to a data input device or port 178 and loaded onto the DPD 110.

The IDED 104 may include any computing device which includes the processing power, memory, and communication capability to interface with the TDNS 102. Non-limiting examples of IDED 104 include mobile phones (including smartphones), electronic tablets, laptop computers, watches, small electronic devices worn as a necklace, bracelet, or other device configured to be attached to a human, and small electronic devices carried or attached in clothing (such as a pen or keychain). The IDED 104 may include a housing and a user interface 144. The user interface 144 may include a display 148 for displaying information to a user, and input devices 146 for allowing the user to enter desired commands or information. The display 148 and input devices 146 may be combined in an interactive touchscreen. However, the display 148 and user input devices 148 may take many forms. The display may, for example include a liquid crystal display (LCD), a light emitting diode (LED) display, or the like. In addition to the touchscreen, non-limiting examples of the user input devices include keyboards, voice activated input devices, buttons, dials, switches, breath activated devices and the like for physically handicapped users, and/or other devices that allow a user to input desired commands and/or information.

The user interface 144 of the IDED 104 and/or a user interface 154 of the DPD 110 may provide functionality to a user of one of more of:
a) Power Down/Sleep Scheduling;
b) Scheduling of Content Transfer from Buffer Drive to Playback Drive (default may be immediate transfer);
c) Scheduling of Content Playback and Queue;
d) Selection of Content Updates for Physical Delivery;
e) Selection of Content Updates for Digital Downloads;
f) Purchase Content and Subscription Management;
g) Channel/Gallery Content Preview (short sample);
h) Search Functionality—Visual Tags (trees, water, night, etc.), Location, Type, Orientation (V or H), Time and Date, Pacing, Name, Quote, Resolution, Featured, Custom, etc.;
i) Access Account, Shipping and Payment Information;
j) Credit Card/Invoice/Bank Routing Information;
k) Selection and Account History;
l) View Buffer Drive Information—Local Queue;
m) View Media Drive Information—Now Playing;
n) USB Media Drive/Hard Drive Query;
o) Auto Update Selections (based on preferences); and
p) Preview Featured and Popular Selections.

The IDED 104 may include the processor 136, and the memory component 138. The processor 136 may include microprocessors or other processors as known in the art and capable of executing instructions, as described below and in relation to FIGS. 2-5, 6A-6B, and 7. In some embodiments the processor 136 may include multiple processors which may be operably connected. Such instructions may be read into or incorporated into a computer readable medium, such as the memory component 138, or provided external to processor 136. The instructions may include multiple lines or divisions of code. The lines or divisions of code may not be in consecutive order, and may not be located in the same section of code. In alternative embodiments, hard-wired circuitry may be used in place of or in combination with software instructions as described above, below, or in relation to the drawings. The memory component 138 may include computer readable storage medium as described above. In some embodiments the memory component 138 may include multiple memory components.

The IDED 104 may include a decoder executable file 142 stored on the memory component 138. The IDED 104 may download the decoder executable file 142 from the TDNS 102. The IDED 104 may include one or more coded image files 140 stored on the memory component 138. The IDED 104 may download the one or more coded image files 140 from the TDNS 102. The IDED 104 may include one or more image files 160, which may be high resolution image files stored on the memory component 138. The one or more image files 160 may include files with one image, multiple images, a sequence of images, and/or audio. The IDED 104 may create the one or more image files 160 from coded image files 140 which may be downloaded from the TDNS 102. The IDED 104 may alternatively load the one or more image files 160 into the memory component 138 from a tangible computer storage medium such as a memory stick and/or a DVD. The memory stick and/or DVD may have been ordered through the TDNS 102. The IDED 104 may include a communication module 184 as described above.

The DPD 110 may include any electronic device which includes the processing power, memory, and communication capability to generate from a high resolution image file 160, and send to the display 112, a video image data stream 174 which produces on the display 112 a sequence of high resolution images at a rate of at least twenty-four (24) frames per second. The DPD 110 may include a processor 150. The processor 150 may be dedicated to producing the video image data stream 174 and executing computer code from a player module 186 as described below. When limited, the processor 150 may operate Intel Celeron Level Processing for HD image files, and i3 Level Processing for UHD image files. This may allow more commercial viability for the DPD 110. However, it is contemplated that other embodiments of the invention will include processors 150 which perform other functions and thus may have increased processing power. In the future, higher power processors to perform other operations may become more commercially viable as their price decreases. The processor 150 may include microprocessors or other processors as known in the art and capable of executing instructions, as described below and in relation to FIGS. 2-5, 6A-6B, and 7. In some embodiments the processor 150 may include multiple processors which may be operably connected. Such instructions may be read into or incorporated into a computer readable medium, such as the memory component 152, or provided external to processor 150. The instructions may include multiple lines or divisions of code. The lines or divisions of code may not be in consecutive order, and may not be located in the same section of code. In alternative embodiments, hard-wired circuitry may be used in place of or in combination with software instructions as described above, below, or in relation to the drawings.

The DPD 110 may include a memory component 152 including computer readable storage medium as described above. In some embodiments the memory component 152 may include multiple memory components. The memory component 152 may include a buffer drive 188 and a playback drive 190. The playback drive 190 may contain one or more image files 160 which the processor 150 generates the video image data stream 174 to create a sequence of images 172 and/or audio on the audio device 170 on the display 112 which may play in a loop. In one embodiment, the playback drive may include a 4 GB RAM minimum and a “visually approved” solid state disk (SSD) or SSD Raid. The buffer drive 188 may cache downloaded image files 160 for download connectivity with the TDNS 102.

The DPD 110 may include a user interface 154 and a player module 186 for controlling functionality of the DPD 110. The player module 186 may control the operation of the DPD 110 in response to a user input to the user interface 154, or user interface 144. The player module 186 may include executable computer program code, and data stored on computer readable storage medium in the memory component 122, which when executed by the processor 120 may implement instructions of the methods shown and described in relation to FIGS. 2-5, 6A-6B and 7. Although illustrated as a single component, the lines or divisions of the executable computer program code and/or data need not be in consecutive order, and may not be located in the same section of code, or in the case of multiple memory components 122, the same memory component 122.

The DPD 110 may be communicatively connected to the IDED 104 to receive image files 140, 160 and/or operating commands. The DPD 110 may include the data input device or port 178, which may be, for example, a USB port connection 180 or a DVD drive 182. Some embodiments of the DPD 110 may include the decoder executable file 142 and coded image files 140 received from the TDNS 102 as described in relation to the IDED 104. Other embodiments will receive the decoded image files 160 from the IDED 104 through communication link 118, or through tangible computer readable media at the data input device or port 178. The DPD 110 may include a communication module 184 as described above. The DPD 110 may be communicatively connected to the display 112 through the communication link 118. The connection between the DPD 110 and display 112 may be any link which is configured to stream video and audio data to the display 112, such that the display 112 may display a sequence of images 172 at a rate of at least twenty-four (24) frames per second.

The display 112 may be any display device which is configured to display a sequence of high resolution images at a rate of at least twenty-four (24) frames per second in response to receiving the video image data stream 174 from the DPD 110. The display 112 may be, for example an HD television, or a UHD television set. Alternatively, the display 112 may simply be a high resolution monitor. The display 112 may include an audio device 170 such as a speaker configured to play audio feed along with the sequence of images 172. Alternatively, a separate audio device (not shown) may be communicatively connected to the DPD 110 to receive audio signals to play along with the sequence of images 172 being shown on the display 112. The display 112 may include a communication module 184 as described above.

The IDED 104 and the DPD 110 may take on a number of different embodiments. In some embodiments, the IDED 104 and DPD 110 are one physical device, and components illustrated separately (such as a processor 136, 150, a memory component 138, 152, or a communication module 184) may actually be one component which performs the functions described for the IDED 104 and the DPD 110. In another embodiment, the IDED 104 and the DPD 110 may be separate devices, and components or functionality described for one of these devices may actually be located or performed, respectively, by the other. In some embodiments, the IDED 104 may be two or more devices. For example, one device may be used to communicate an order for an image file 140, 160 to the TDNS 102, and the image file 140, 160 may be downloaded to another device. The IDED 104 and the DPD 110 may be communicatively connected through communication link 118, or may communicate through the communication network 116. In some embodiments, the coded image file 140 may be downloaded to the IDED 104, decoded on the IDED 104, and then saved to a tangible storage medium such as a memory stick. The memory stick may then be connected to a data input device or port 178 and loaded onto the DPD 110.

The ICED 106 may include any computing device which includes the processing power, memory, and communication capability to code high resolution image files 160 to generate coded image files 140, and interface with the TDNS 102. Non-limiting examples of ICED 106 include mobile phones (including smartphones), electronic tablets, laptop computers, and desktop computers. The ICED 106 may include a housing and a user interface 164. The user interface 164 may include a display 168 for displaying information to a user, and input devices 166 for allowing the user to enter desired commands or information. The display 168 and input devices 166 may be combined in an interactive touchscreen. However, the display 148 and user input devices 148 may take many forms. The display may, for example include a liquid crystal display (LCD), a light emitting diode (LED) display, or the like. In addition to the touchscreen, non-limiting examples of the user input devices include keyboards, voice activated input devices, buttons, dials, switches, breath activated devices and the like for physically handicapped users, and/or other devices that allow a user to input desired commands and/or information.

The user interface 164 may also include software which may allow a user who wishes to provide photographic or other high resolution art to interface with the TDNS 102 to download the coder executable file 162, manage payments and accounts, and upload coded image files 140 for display, sale, and distribution to consumers through the TDNS 102. The display module 134, for example, may contain computer code and data, which may send information to the ICED 106 through which a web browser for a computer (or app for a tablet or phone) may then provide the user interface 164 for the photographic art provider.

The ICED 106 may include the processor 156, and the memory component 158. The processor 156 may include microprocessors or other processors as known in the art and be capable of executing instructions, as described below and in relation to FIGS. 2-5, 6A-6B, and 7. In some embodiments the processor 156 may include multiple processors which may be operably connected. Such instructions may be read into or incorporated into a computer readable medium, such as the memory component 158, or provided external to processor 156. The instructions may include multiple lines or divisions of code. The lines or divisions of code may not be in consecutive order, and may not be located in the same section of code. In alternative embodiments, hard-wired circuitry may be used in place of or in combination with software instructions as described above, below, or in relation to the drawings. The memory component 158 may include computer readable storage medium as described above. In some embodiments the memory component 158 may include multiple memory components.

The ICED 106 may include a coder executable file 162 stored on the memory component 158. The ICED 106 may download the coder executable file 162 from the TDNS 102. The ICED 106 may include one or more coded image files 140 stored on the memory component 158. The ICED 106 may create the one or more coded image files 140 with the coder executable file 162 from high resolution image files 160. The ICED 106 may upload the coded images files 140 to the TDNS 102. The ICED 106 may include one or more high resolution image files 160, which may include files with one image, multiple images, a sequence of images, and/or audio. The ICED 104 may download the one or more high resolution image files 160 from the image creation device 108, or from a content server 114.

The image creation device 108 may include any type of camera configured to create high resolution images 160. The image creation device 108 and the ICED 106 may be parts of a single device, or they may be separate devices. The image creation device 108 may be communicatively connected to the ICED 106 through communication link 118, or images may be transferred through a tangible computer readable storage medium such as a memory stick, or a memory card. A high resolution image file 160 may be created through one or more other high resolution image files and audio files with software as is known in the art. The creation may be done by the ICED 106, or another device. The content server 114 may be any content server allowing the user/provider to store image files 160. Cloud servers are well known in the art. Image files 160 may be downloaded from the content server 114 to ICED 106, and then uploaded to the TDNS 102, or ICED 106 may generate control commands to upload the image files 160 directly from the content server 114 to the TDNS 102.

ICED 106 may include the communication module 184 as described above, and be communicatively connected with the TDNS 102, and the content server 114 through communication links 118 and network 116.

### INDUSTRIAL APPLICATION

Referring now to FIG. 2 an exemplary method 200 for transmitting, receiving, and displaying high resolution images, is illustrated in a diagram. The image creation device block 108 illustrates the creation of a high resolution image file 160. The image creation device 108 is illustrated as a camera 202, but may include other forms as well. For example the image creation device 108 could include an audio recording device (not shown), software to create a multiple image file with audio, and/or software to create images and audio. The image files 160 may be transferred to the ICED 106. Alternatively, the image files 160 may be transferred to the content server 114, for the ICED 106 or the TDNS 102 to download from. The image file 160, may for example be a time lapsed photography video of a sunset, or flowers and grass swaying in the wind. Audio may be added. The photographic frames of the image file 160 may be high resolution images.

The ICED box 106 illustrates the coding of the image file 160 into a coded image file 140. The ICED 106 is illustrated as a computer 204, and in specific a laptop computer 206. However, the ICED 106 could take other forms as well. The ICED 106 may download the coder executable file 162 from the TDNS 102. Before doing this, the user/provider of photographic art may access the TDNS 102 through the ICED 106 (or other electronic computer device) and set up an account with payment and other personal information, as is known in the art. Because it may not economical, in both time and data transfer charges, to transfer even a short video with high resolution images through a network 116 and communication links 118, a provider may compress the image file 160 into a smaller coded image file 140 using the coding portion of a lossless codec. The lossless codec may be designed specifically for compressing, without image loss one or more high resolution images, for later decoding into an image file 160 which when played by the DPD will generate the video image data stream 174 to the display 112. The ICED 106 may upload the coded image file 140 to the TDNS 102 for distributing to consumers.

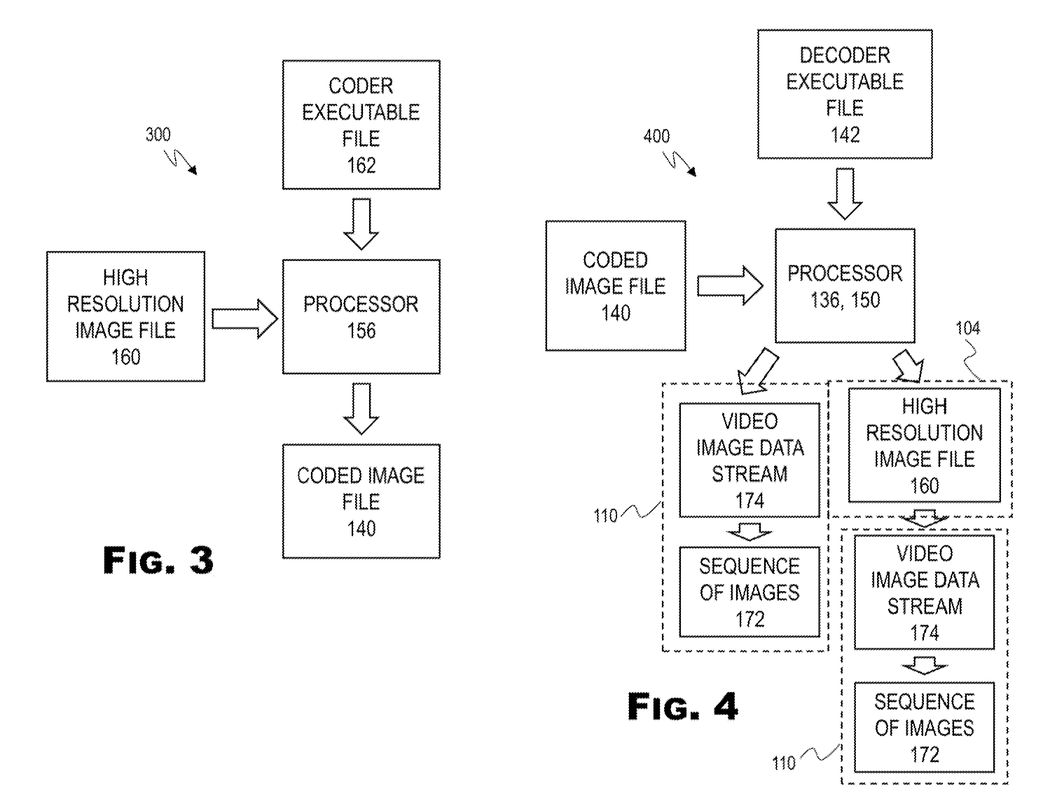

Referring now to FIG. 3, an exemplary method 300 for creating a smaller lossless coded image file from a high resolution image file, is illustrated in a block diagram. The processor 156 may execute the code in the coder executable file 162, using the high resolution image file 160 as a data file. The execution by the processor 156 generates the coded image file 140 which is smaller in size than the image file 160, but retains all the image information which was in the original file.

Referring back to FIG. 2, The TDNS 102 block illustrates how the TDNS 102 interfaces with the ICED 106 and IDED 104. The TDNS 102 may allow download of the coder executable file 162 to the ICED 106 for use by providers of photographic art in compressing high resolution image files 160. The provider may be required to set up an account and pay a licensing fee to do this. The TDNS may allow download of the decoder executable file 142 to the IDED 104 for consumers of the photographic art to decode the coded image files 140 to image files 160 which will play on the display 112 through the DPD 110, or decode the coded image file 140 directly to a video image data stream 174. The consumer may be required to set up an account and pay a licensing fee to do this. Alternatively, the decoder executable file 142 may be provided when a purchase of photographic art is made.

The TDNS 102 allows providers to provide photographic art in the form of coded image files 140 for storage in the image library database 32, for display through the user interface 144, for purchase by consumers, and/or for distribution to consumers. Alternatively, a provider may provide uncompressed image files 160 through sending the files on a tangible computer readable storage medium, such as a memory stick, or DVD, to the TDNS 102. The image files 160 may then be loaded into the image library database 132, and compressed if needed to send to consumers. The TDNS 102 provides consumers information and illustrations of the photographic art in the image library database 132, for purchase, and allows download of coded images 140 to the IDED 104 and/or DPD 110. Alternatively, consumers may purchase uncompressed image files 160 to be delivered on a tangible computer readable medium, for playing on the DPD 110 and display 112.

The IDED 104 block illustrates the IDED 104 interfacing with the TDNS 102 (as described above) and the DPD 110. The IDED 104 is illustrated as a computer 204, and in specific a laptop computer 206, but may take many other forms as described above. A consumer of photographic art may use the IDED 104 to interact with the TDNS 102 and select photographic art in the form of coded image files 140 to download to the IDED 104, or alternatively, directly to the DPD 110. The processor 136 of the IDED 104 may decode the coded image file 140 to a high resolution image 160 for transfer to the DPD 110, or alternatively send the coded image 140 to the DPD 110 for the processor 150 to decode.

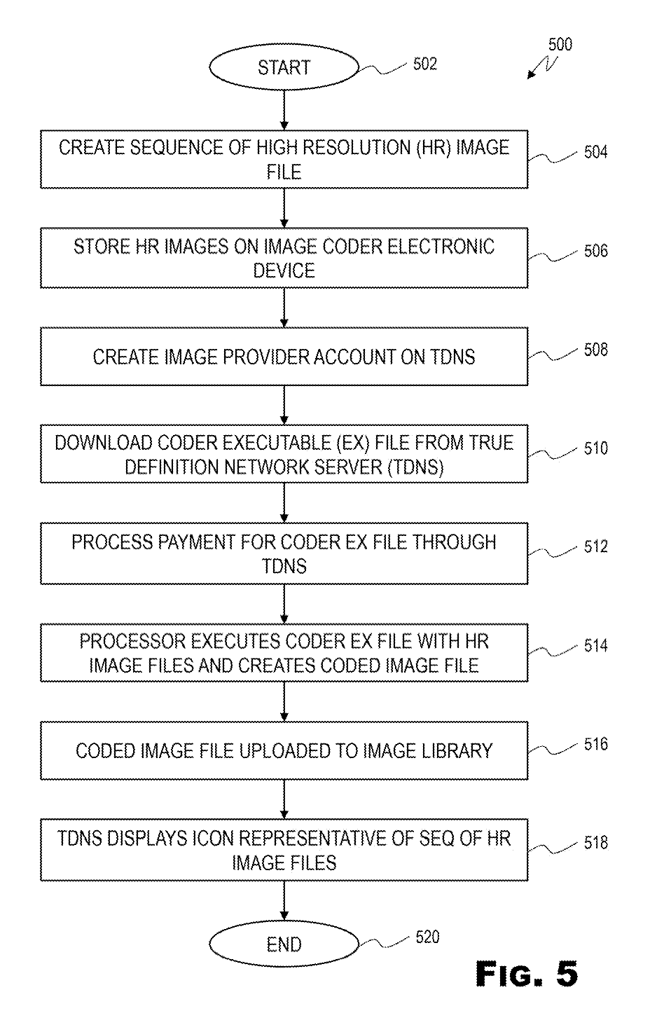

Referring now to FIG. 4, an exemplary method 400 for creating a display of a sequence of high resolution images 172 from a lossless coded image file 140 is illustrated in a block diagram. The processor 136, 150 in the IDED 104 or the DPD 110 may execute the code in the decoded executable file 142, with data from the coded image file 140 to create a video image data stream 174 (in the case of the DPD 110), or a high resolution image file 160 (in the case of the IDED 104). The video image data stream 174 or the high resolution image file 160 will contain all the image data of the original high resolution data file 160 which was used to create the coded image file 140 with the coder executable file 162.

If the coded image file 140 was decoded by the IDED 104, the resulting high resolution image file 160 may be transferred to the DPD 110 through a communication link 118, or through a tangible computer storage medium which is then connected to the data input device or port 178. The DPD 110 may then create the video image data stream from the high resolution image file 174. Whether created directly from the coded image file 140, or the high resolution image file 160, the video image data stream 174 may be transmitted to the display 112 at a rate which may produce a sequence of high resolution images 172 at a minimum rate of twenty-four (24) frames per second.

Referring back to FIG. 2, the DPD 110 block illustrates the operation of the DPD 110 in an exemplary embodiment as explained above.

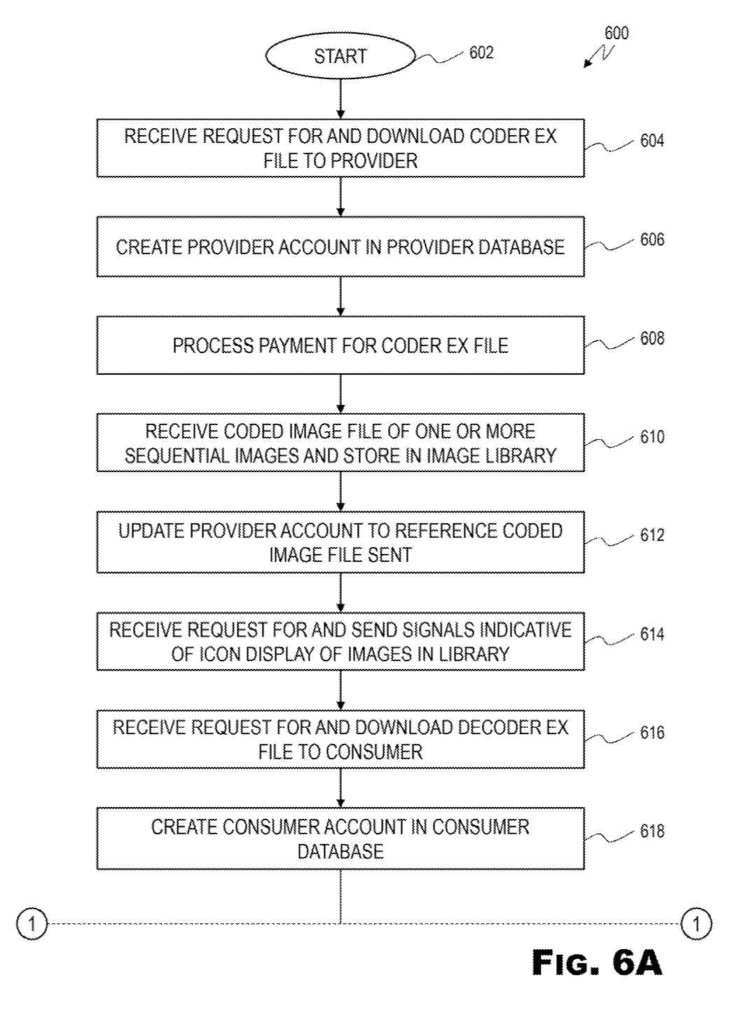

Referring now to FIG. 5, exemplary method 500 of providing high resolution image files to a computer network marketplace is illustrated in a flow chart. The method 500 starts at 502. A photographic artist who creates high resolution image art may desire to provide his/her art to consumers who own high resolution displays, such as televisions. Very few forms of media which actually show video in high resolution are available commercially to a consumer. Although the consumer may have a high resolution display which is able to display high resolution mediums, there may be little opportunity to utilize the full capability of this feature. Digital photography equipment is available to photographic artists to create videos of high resolution images with and without audio. Editing and media creation software is available to edit the raw photographic images and audio, or add other audio to a video presentation. However, the photographic artist may be unable to distribute his/her work to consumers, and consumers may not have equipment with the capability of showing this work on their high resolution displays. A provider (creator) of photographic art may utilize method 500 to address part of this problem.

The provider may create an electronic data computer file digital information on a sequence of high resolution images 172—the high resolution image file 160. The image file 160 may also contain audio data for audio to play with the sequence of high resolution images 172. The image file 160 may be created with a camera or other photographic device, an audio recorder, software to edit and create media, and/or other image file 160 creation devices as known in the art (step 504). The image file 160 may be stored on the ICED 106 (step 506).

The provider may interface with the TDNS 102, with for example the user interface 164 to create an account with the TDNS 102. The TDNS may store information entered by the provider in the image provider database 128. The information may include, for example, payment information such as a credit card or bank account, information for crediting of consumer payments, contact information, information on the ICED 106, and other information as known in the art for creating provider accounts in an electronic marketplace (step 508). The provider may download the coder executable file 162 from the TDNS 102 to the ICED 106 (step 510), and a payment may be processed by the payment processing module 135 with information from the provider's account, or information provided by the provider through the user interface 164 (step 512).

The processor 156 may execute the coder executable file 162 with data from the image file 160 to create the coded image file 140. The coded image file 140 may be smaller than the image file 160, but may retain one hundred percent (100%) of the high resolution image data (step 514). The provider may upload the coded image file 140 to the TDNS, along with descriptive information, and/or purchase information (such as what price to charge consumers). The TDNS 102 may store the coded image file 140 in the image library database 132, along with data indicative of the provider and/or linking the images to the provider account (step 516). The display module 134 may provide information through the user interface 144 for the consumer to view icons, short lower resolution previews, pricing, or other information representative or indicative of the sequence of images 172 and/or audio contained on the coded image file 140 (step 518). The method 500 ends at 520.

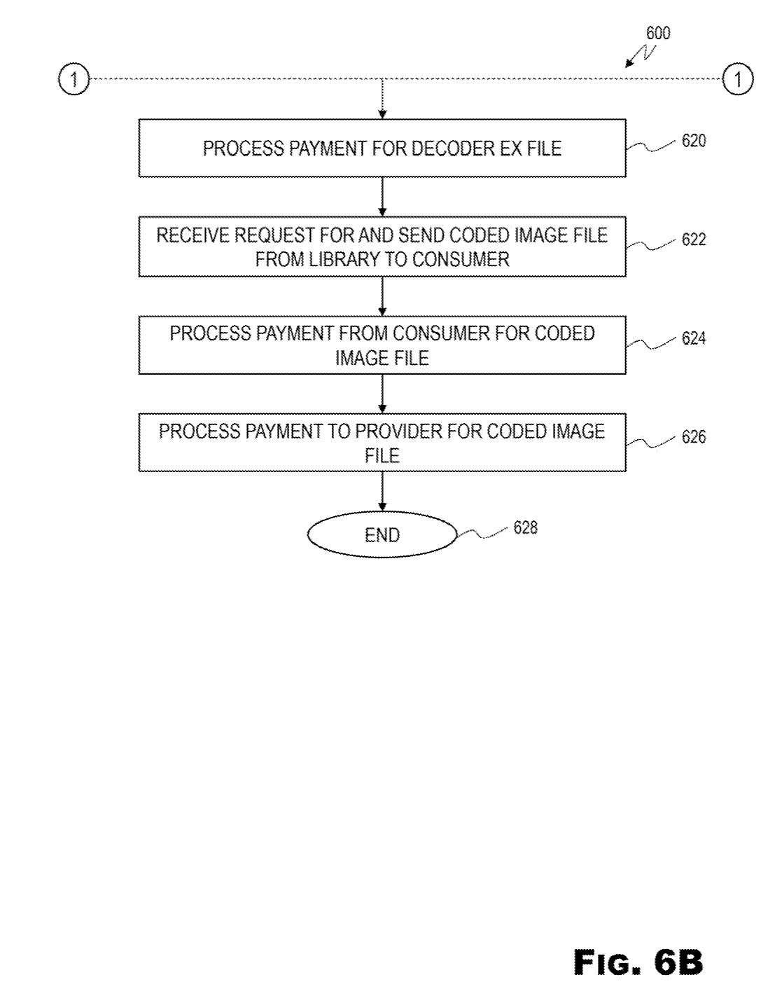

Referring now to FIG. 6A, a first portion of an exemplary method 600 of providing a computer network marketplace, is illustrated in a flow chart. The method 600 starts at 602. The TDNS 102 may implement a computer network electronic marketplace to provide high resolution photographic art to consumers, and to provide a channel for distribution of photographic art to providers. The electronic marketplace, is made possible, in part, through the use of a lossless codec for transferring compressed image files, which still retain all image data, between the provider, the TDNS 102, and the consumer. However, it is contemplated that providers, and consumers may, in some cases, still be able to transfer and obtain uncompressed files through shipments on tangible computer readable mediums, such as memory sticks and DVDs. The playing of high resolution video and audio files by consumers may be made commercially viable through players which direct the power of the processor to producing the video image data stream and other display controls, rather than other computer tasks.

As described above, the TDNS 102 may receive requests from providers for the coder executable file 162, create providers accounts, and process payments for the coder executable file 162, and transfer the coder executable file 162 to the ICED 106 (steps 604, 605, 608). The TDNS 102 may receive coded image files 140 from providers, store the coded image files 140 in the image library database 132, and update the provider account and/or the image library database 132 to associate each coded image 140 with the provider of the image (steps 610, 612).

When a consumer interfaces with the TDNS 102 through the IDED 104, such as for example through an Internet browser, the IDED 104 may send requests to the TDNS 102 for information on coded image files 140 available for purchase and/or download. In response the display module 134 may send signals to the IDED 104 such that the consumer may receive information via the user interface 144 on the image files 140 available for purchase, and purchase information such as price (step 614). If the consumer has not already obtained a license to, and/or downloaded the decoder executable file 142, the TDNS 102 may receive a request for the decoder executable file 142. In response, the TDNS 102 may send the decoder executable file 142 to the IDED 104, the DPD 110, or another electronic device designated by the consumer through the user interface 144 (step 616). Before downloading the decoder executable file 142, or in response to a request for image files 160, the TDNS 102 may check the image consumer database to see if the consumer making the request has a consumer account set up. If the TDNS 102 determines that the consumer making the request does not have a consumer account, a request for information to set up the account may be sent to the IDED 104. The TDNS 102 may set up a consumer account in the image consumer database in response to information from the consumer entered through the user interface 144. This information may include, for example, payment information, contact information, information on locations (IP addresses for example) of the IDED 104, the DPD 110, and/or other electronic devices, consumer preferences, and/or other information generally entered to set up consumer accounts in an electronic marketplace, as is known in the art (step 618). The method 600 may proceed to steps illustrated in FIG. 6B.

Referring now to FIG. 6B, a second portion of the exemplary method 600 of FIG. 6A is illustrated in a flow chart. The payment processing module 135 may process payment for the decoder executable file 142 with information from the consumer account, as is known in the art (step 620). The TDNS 102 may receive a request for a coded image file 140 from a consumer through the IDED 104 (step 622). The TDNS may download the coded image file to the IDED 104, the DPD 110, or another electronic device, as indicated by the consumer through the user interface 144 (step 624). In an alternative embodiment, the consumer may request that the coded image file 140, or a high resolution image file 160 created from decoding the coded image file 140 be shipped to a specified location on a tangible computer readable medium, and the delivery module 133 may generate any commands needed such that the shipment occurs.

The payment processing module 135 may process a payment from the consumer for the coded image file 140 (or alternatively the high resolution image file 160), utilizing information in the image consumer database, as is known in the art (step 624). The payment processing module 135 may also process a payment to the provider who provided the coded image file 140, in accordance with any payment agreements or arrangements, utilizing information in the image provider database 128 (step 626). The method 600 ends at 628.

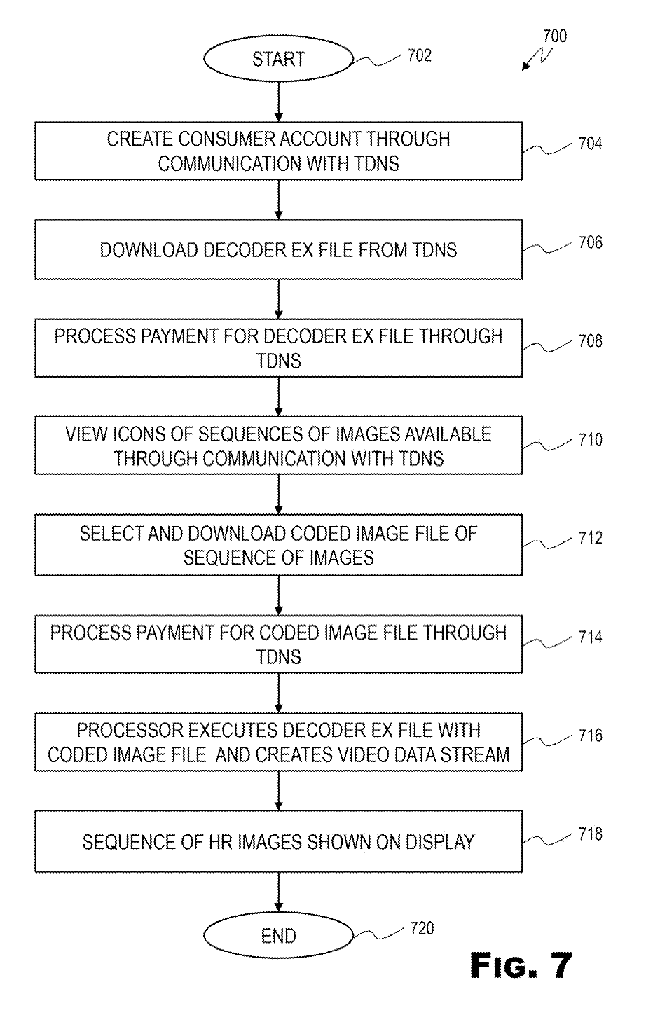

Referring now to FIG. 7, an exemplary method 700 of displaying a sequence of high resolution images 172 from a computer network marketplace on a display 112 is illustrated in a flow chart. A consumer may desire to purchase high resolution media which will play in high resolution on their high resolution display 112. For example, a consumer who has a room without many windows may mount displays 112 on the walls and play scenes from the outdoors. These scenes may include, for example, time lapse photography, or video photography of nature or city scenes. The video may be of a predetermined length, and may play over and over again in a loop. Other consumers may simply desire alternative high definition art for their home. Some commercial consumers may desire a display which will attract customers into their business place, or provide a soothing atmosphere. These consumers may obtain the photographic art through download from the TDNS 102 with the IDED 104. A consumer may access the TDNS through the user interface 144. The user interface may, for example, include a web browser, or mobile web browser app. The display module 134 may send information to the user interface 144 to allow the consumer to create a consumer account (step 704), download the decoder executable file (step 706), pay for the decoder executable file (step 708), and view coded image file 140 information on photographic art available in the image library database (step 710), as described above.

The consumer may select photographic art they desired to purchase through the user interface 144, and select the location the coded image file 140 should be downloaded to. The location may be the IDED 104, the DPD 110, another electronic device, or a content server the IDED or other electronic device may access. In response to the selections, the TDNS 102 may download the coded image file 140 selected (step 712). In an alternative embodiment, the consumer may select physical delivery to a location of the coded image file, or the high resolution image file 160 on a tangible computer readable medium. The consumer may select, through the user interface 144, to pay for the coded image file 140 through a method already designated and recorded in their account in the image consumer database. Alternatively, the consumer may select another method and enter necessary payment information for the payment processing module 135 to process their payment (step 714).

The processor 136, 150 of the IDED 104 or the DPD 110 may execute the decoder executable file 142 with data from one of the coded image files 140 from the TDNS 102, to create the video image data stream 174 as described above in relation to FIG. 4 (step 716). In response to the video image data stream being transmitted by the DPD 110 to the display 112, a sequence of high resolution images 172, identical to the images on the image file 160 originally created by the photographic artist, shows on the display 112. Audio may also play on the audio device 170 along with the sequence of images 172 (step 718). The method 700 ends at 720.

It should be understood, of course, that the foregoing relates to exemplary embodiments of the invention and that modifications may be made without departing from the spirit and scope of the invention as set forth in the following claims.

I claim:

1. A system for displaying high resolution images on a high resolution display, comprising:
a network server comprising:
an image library database including multiple coded image files, each image file configured to be decoded into a video image data stream when a decoder executable file is executed by a processor, each coded image file: a) created from one or more high resolution image files with a coder executable file, b) including all of the image data included in each high resolution image file, and c) having a size smaller than the total size of all the one or more high resolution image files; the video image data stream including all the image data of the one or more high resolution image files;
a display module for transmitting display information in response to a display request, the display information including information on the coded image files included in the image library database; and a user interface for selecting and downloading coded image files; and
a first electronic device communicatively connected to the network server and including a user interface for receiving display information, and selecting and downloading coded image files; the first electronic device configured to execute the decoder executable file with data from a downloaded coded image file and generate the video image data stream; and
a high resolution display communicatively connected to the first electronic device and configured to generate a sequence of high resolution images in response to receiving the video image data stream from the first electronic device at a rate of at least twenty-four frames per second.

2. The system of claim 1, wherein the first electronic device includes an image decoder electronic device communicatively connected to the network server and including the user interface, the image decoder electronic device including a processor configured to execute the decoder executable file with data from the downloaded coded image file and generate a readable image file, the readable image file including all the image data from the one or more high resolution image files used to create the coded image file.

3. The system of claim 2, wherein the first electronic device further includes a display player device including a buffer drive, a playback drive, and a processor, the display player device communicatively connected to the image decoder electronic device to receive the readable image file in the buffer drive, and the processor configured to transfer the readable image file from the buffer drive to the playback drive, and generate and transmit the video image data stream to the high resolution display.

4. The system of claim 2, wherein:
the image decoder electronic device is configured to save the readable image file to a tangible computer readable storage medium.
the first electronic device further includes a display player device including a data input device or port configured to receive the tangible readable storage medium with the stored readable image file, a playback drive, and a processor; the processor configured to transfer the readable image file from the tangible readable storage medium to the playback drive, and generate and transmit the video image data stream to the high resolution display.

5. The system of claim 1, wherein the first electronic device includes a display player device communicatively connected to the network server to receive one or more coded image files from the image library database, and communicatively connected to the high resolution display; the display player device including a processor configured to execute the decoder executable file with data from the downloaded coded image file, and generate the video image data stream.

6. The system of claim 5, wherein the first electronic device further includes an image decoder electronic device communicatively connected to the network server and including the user interface, the image decoder electronic device configured to designate the location of the display player device for downloading one or more coded image files.

7. The system of claim 1, further including a second electronic device communicatively connected to the network server for uploading coded image files from photographic art providers to the image library database.

8. A computer program product, comprising:
a computer readable storage medium, and
computer usable code stored on the computer readable storage medium, where, if executed by a processor, the computer readable code causes a computer to:
receive a coded image file from an image provider via an image coder electronic device, the coded image file created from one or more high resolution image files with a coder executable file, the coded image file including all of the image data included in each high resolution image file, and the coded image having a size smaller than the total size of all the one or more high resolution image files;
store the coded image file in an image library database;
transmit display signals to an image decoder electronic device, in response to a request for available coded image file information from an image consumer via the image decoder electronic device, the display signals indicative of information on the coded image file and other image files available in the image library database; and
transmit the coded image file in response to an image request from the image consumer via the image decoder electronic device to an electronic device, the location of the electronic device designated by the image request.

9. The computer program product of claim 8, wherein the high resolution image file includes a sequence of high resolution images, and the coded image file includes all the image data for each high resolution image in the sequence of high resolution images.

10. The computer program product of claim 8, wherein the coded image file is created from a high resolution image and an audio file, and the coded image file includes all the audio data from the audio file.

11. The computer program product of claim 8, wherein the coded image file is configured to be decoded into a video image data stream including all the image data included in each high resolution image file by a computer processor executing a decoder executable file with data from the coded image file.

12. The computer program product of claim 11, wherein when the video image data stream is transmitted to a high resolution display, the high resolution display displays a sequence of high resolution images, each high resolution image identical to one of the high resolution images which created the coded image file.

13. The computer program product of claim 8, wherein the coded image file is configured to be decoded into a high resolution image file including all the image data included in each high resolution image file by a computer processor executing a decoder executable file with data from the coded image file.

14. The computer program product of claim 8, wherein the computer readable code further causes the computer to receive account information for the image provider via the image coder electronic device, and create an image provider account for the image provider in an image provider account database.

15. The computer program product of claim 8, wherein the computer readable code further causes the computer to receive a request from the image provider via the image coder electronic device for the coder executable file; and transmit the coder executable file to the image coder electronic device.

16. The computer program product of claim 8, wherein the computer readable code further causes the computer to receive account information for the image consumer via the image decoder electronic device, and create an image consumer account for the image consumer in an image consumer account database.

17. The computer program product of claim 8, wherein the computer readable code further causes the computer to receive a request from the image consumer via the image decoder electronic device for the decoder executable file; and transmit the decoder executable file to the image decoder electronic device.
